(19) United States
(12) Patent Application Publication
(10) Pub. No.: US 2011/0052208 A1
(43) Pub. Date: Mar. 3, 2011

(54) OPTOELECTRONIC WIRING FILM AND OPTOELECTRONIC WIRING MODULE

(75) Inventor: Hideto Furuyama, Kanagawa-ken (JP)

(73) Assignee: KABUSHIKI KAISHA TOSHIBA, Tokyo (JP)

(21) Appl. No.: 12/872,928

(22) Filed: Aug. 31, 2010

(30) Foreign Application Priority Data
Aug. 31, 2009 (JP) 2009-200810

(51) Int. Cl. H04B 10/04; G02B 6/122

(52) U.S. Cl. 398/182; 385/14

(57) ABSTRACT

In one aspect of the invention, the optoelectronic wiring film may include an optical waveguide; a ground wiring; and a source wiring supplying power and being provided in the same wiring layer as the ground wiring, wherein the source wiring has a comb-shaped portion and the ground wiring has a comb-shaped portion, a gap between the source wiring and the ground wiring is substantially constant, and the comb-shaped portion of the source wiring and the comb-shaped portion of the ground wiring face each other so that the gap between the source wiring and the ground wiring meanders.

### CROSS REFERENCE TO RELATED APPLICATION

This application is based upon and claims the benefit of priority from Japanese Patent Application No. 2009-200810, filed on Aug. 31, 2009, the entire contents of which are incorporated herein by reference.

### FIELD

Embodiments herein describes herein relate generally to an optoelectronic wiring film and an optoelectronic wiring module.

### BACKGROUND

Improvement in performance of electronic devices such as a bipolar transistor, a field-effect transistor and the like has lead to significant improvement in the operation speed of large-scale integrated circuits (LSI), which, in turn, has raised problems of speed limitations and malfunction due to electromagnetic noise in electric wirings for connecting such devices. Several optical wiring devices configured to optically transmit signals have been proposed to solve such wiring problems. Also, a conventional art such as that disclosed in Japanese Patent Application Publication No. 3-58532A is known as a technique to reduce power consumption of optical wirings.

An optical wiring requires power supplies on both transmitting and receiving sides. Battery-driven devices such as mobile devices have a power supply on only one of the transmitting and receiving sides and therefore need an electric wiring in addition to an optical wiring. Therefore, there are problems that noise superimposed on the electric wiring is transmitted and also that it is difficult to apply a conventional optoelectronic wiring module to a battery-driven device such as a mobile terminal device due to high power consumption of the optical wiring.

### BRIEF DESCRIPTIONS OF THE DRAWINGS

A more complete appreciation of the invention and many of the attendant advantages thereof will be readily obtained as the same becomes better understood by reference to the following detailed description when considered in connection with the accompanying drawings.

FIG. 1 is a schematic perspective view of an optoelectronic wiring film according to a first embodiment of the present invention.

FIG. 2 is a schematic top view of the optoelectronic wiring film according to the first embodiment of the present invention.

FIG. 3 is a schematic cross sectional view of the optoelectronic wiring film according to the first embodiment of the present invention.

FIG. 4 is a schematic top view of an optoelectronic wiring film according to a second embodiment of the present invention.

FIG. 5 is a schematic top view of an optoelectronic wiring film according to a third embodiment of the present invention.

FIG. 6 is a schematic configuration diagram of an optoelectronic wiring module according to a fourth embodiment of the present invention.

### DETAILED DESCRIPTION

Various connections between elements are hereinafter described. It is noted that these connections are illustrated in general and, unless specified otherwise, may be direct or indirect and that this specification is not intended to be limiting in this respect.

In the embodiments, an optical wiring is integrated with a source wiring while AC-coupling the source wiring, and noise is reduced.

The present embodiments provide an optoelectronic wiring film including at least an optical waveguide and an electric wiring for supplying power, in which a source wiring of the electric wiring and a ground wiring are provided in the same wiring layer and the source wiring and the ground wiring face each other in comb-shaped portions while meandering by keeping a gap therebetween substantially constant. Preferably, multiple regions where the gap between the source wiring and the ground wiring meanders at different pitches are provided to reduce resonance effect in the source wiring. Further, a low-speed signal line may be further provided in the same wiring layer as the source wiring and the ground wiring and disposed in the gap between the source wiring and the ground wiring.

The present embodiments provide a optoelectronic wiring module using the optoelectronic wiring film described above, which is configured to supply power from only one of an optical transmission side or an optical reception side of the optoelectronic wiring film and to supply power by use of the source wiring and the ground wiring of the optoelectronic wiring film to an optical element drive circuit on each of the optical transmission side and the optical reception side. The optoelectronic wiring module optically transmits digital signals, and includes two optical waveguides having approximately the same lengths. Preferably, pulse rise information of the inputted digital signal is optically transmitted through one of the optical waveguides, while pulse fall information of the inputted digital signal is optically transmitted through the other optical waveguide.

Hereinafter, embodiments according to the present invention will be described with reference to the accompanying drawings. Here, several specific materials and circuits are used as examples. However, the present invention is not limited to the following embodiments and can be embodied similarly using materials and circuits having similar functions.

### First Embodiment

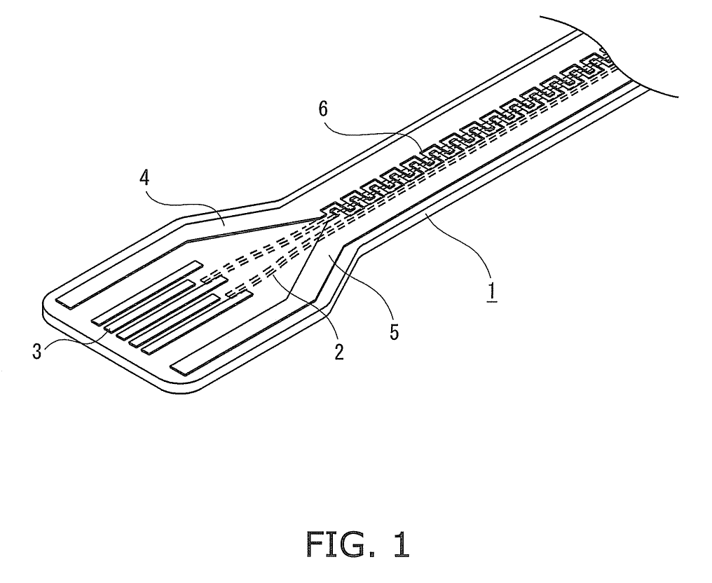

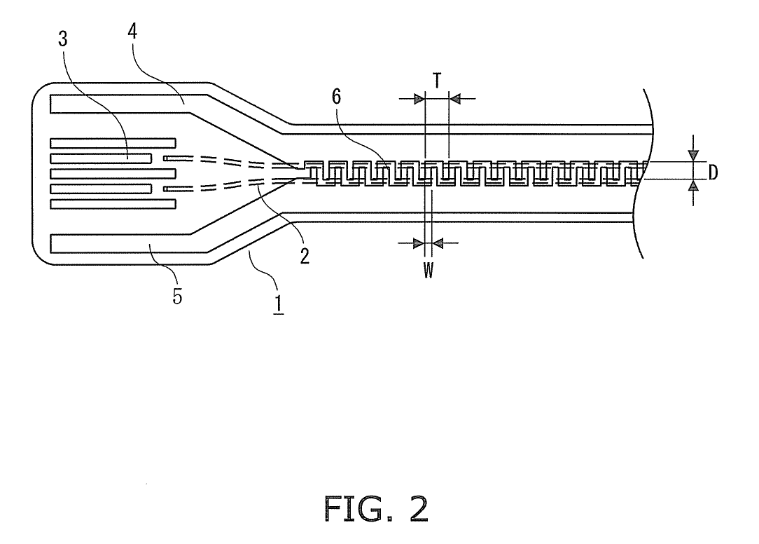

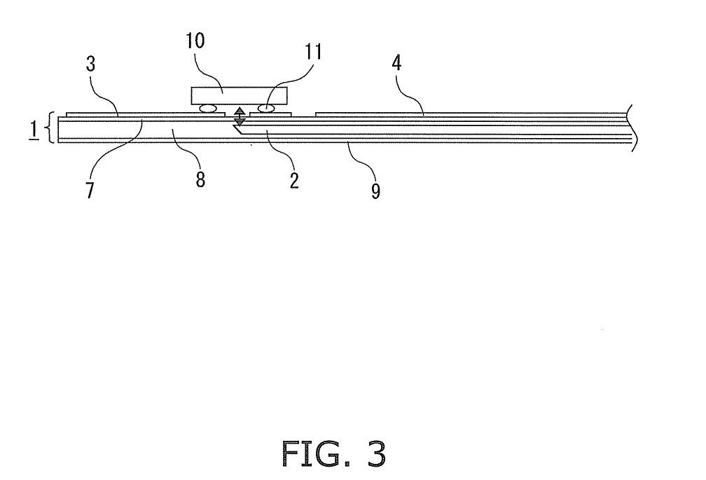

FIG. 1 is a schematic perspective view of an optoelectronic wiring film according to a first embodiment of the present invention. FIG. 2 is a top view of the optoelectronic wiring film shown in FIG. 1. FIG. 3 is a sectional side view of an optical waveguide of the optoelectronic wiring film shown in FIG. 1.

In FIG. 1, 1 represents the optoelectronic wiring film, 2 represents an optical waveguide core (optical wiring path), 3 represents an electric wiring, 4 represents a source wiring, 5 represents a ground wiring, 6 represents a meandering gap between the source wiring 5 and the ground wiring (a comb-shaped opposing portions) 5. In FIG. 3, 7 represents a substrate film such as polyimide, 8 represents an optical waveguide cladding (an optical confinement layer) and 9 represents a back surface protection layer. Although a surface protection layer (solder resist) and the like are omitted in these figures, such components may be provided as appropriate. The optical waveguide core 2 and the optical waveguide cladding 8 are made of resin materials having different indexes of refraction, for which various materials such as epoxy resin, acryl resin, polyimide resin and the like may be used.

The optoelectronic wiring film 1 of this embodiment configured enables definite provision of the shape and the positional relation of the source wiring 4 and the ground wiring 5, so that power source characteristics and the like can be considered in designing of the shape pattern thereof.

Consequently, the source wiring 4 is not disposed simply in parallel with the ground wiring 5, but a gap 6, which has a meander shape in plan view, is formed between the source wiring 4 and the ground wiring 5 as shown in FIGS. 1 and 2 so that electrostatic capacitance coupling between electrodes can be enhanced to thereby suppress propagation of noise components.

As shown in FIG. 2, the source wiring 4 and the ground line 5 face each other. On a side of the source wiring 4 facing to the ground line 5, a plurality of protrusions and recesses are formed in the source wiring 4. On a side of the ground wiring 5 facing to the source line 4, a plurality of protrusions and recesses are formed in the ground wiring 5. The protrusions and recesses of the source wiring 4 and the protrusions and recesses of the ground wiring 5 are inserted with keeping a gap, and the gap 6 is formed between the source wiring 4 and the ground wiring 5.

The source wiring 4 has a comb-shaped portion on the side of the ground wiring 5 facing to the source line 4. The ground line 5 has a comb-shaped portion on the side of the source wiring 4 facing to the ground line 4.

For example, as shown in FIG. 2, a comb-shaped electrode cutting into a region of opposing electrodes can be formed by providing a gap (W) of 50 μm between the source wiring 4 and the ground wiring 5 and a meandering width (D) of 50 μm or more. In this case, to keep the gap W constant and ensure that the width of the comb-shaped electrode is W or more, the meandering pitch (T) may be set to 200 μm or more. The width in which the source wiring and the ground wiring face each other in parallel is T+2D−4W. Therefore, with at least D≧2W+T/2, the width in which electrodes face each other, that is an interelectrode capacitance, increases compared with a simple parallel arrangement. Even with D=2W+T/2, there is a capacitance increase at corners of the comb-shaped electrode and therefore electrostatic capacitance larger than the simple parallel arrangement is generated. That is, in the case of W=50 μm, electrostatic capacitance increases positively with D≧150 μm. Further, chamfering the corner of a comb-shaped concave portion to a ¼ circle with the radius W, maximum interelectrode capacitance can be generated while keeping the gap W constant.

Further, the optoelectronic wiring film 1 enables forming of an electrode such as an optical element, a driver IC and the like to be mounted thereon. Thus, the optoelectronic wiring film 1 can be compactly modularized only by mounting a chip thereon. This can be achieved by flip chip mounting or the like of a chip 10 (optical element or driver IC) using a bump metal 11 as shown in FIG. 3.

In an optoelectronic wiring film 1 according to the present embodiment, the source wiring 4 and the ground wiring 5 extend in substantially the same direction, except in comb-shaped portions 6 provided on the side where the source wiring 4 and the ground wiring 5 face each other as shown in the top view. Each of the wirings 4 and 5 is disposed so that a comb-shaped portion of the source wiring 4 and a comb-shaped portion of the ground wiring 5 are disposed alternately in a manner not to contact each other.

In an optoelectronic wiring film 1 according to the present embodiment, interelectrode capacitance between the source wiring 4 and the ground wiring 5 can be increased, whereby propagation of noise components can be suppressed.

### Second Embodiment

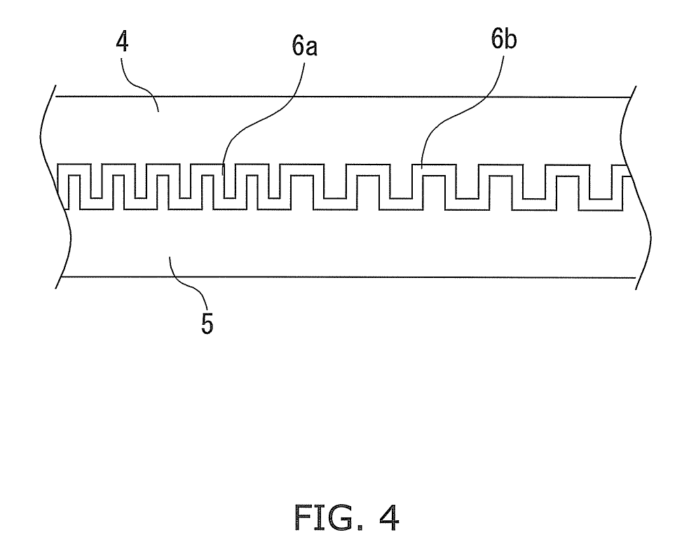

FIG. 4 shows a second embodiment of the present invention, in which the gap W between the source electrode 4 and the ground electrode 5 and the meandering width D are the same as the first embodiment but the meandering pitch T is modified to 6a and 6b. The meandering pitches 6a has smaller pitch than the meandering pitches 6b, as shown in FIG. 4. This configuration prevents resonance passing of frequency components which can resonate in the pitch at which the gap between electrodes meanders. That is, frequency which can resonate in a single meandering pitch cannot resonate in a meandering portion having a different pitch, and thus a situation in which a specific frequency propagates without being attenuated can be prevented.

Although two types of the meandering pitches 6a and 6b are provided in the present embodiment, more than two types of the meandering pitches may be provided. As the number of the meandering pitch T increases, propagation of frequency noise corresponding to the number of the meandering pitch T can be suppressed.

In an optoelectronic wiring film according to the present embodiment, multiple meandering pitches are provided while the meandering width and the gap between the source electrode and the ground electrode are kept constant.

In an optoelectronic wiring film according to the present embodiment, as compared to the optoelectronic wiring film according to the first embodiment, noise of a specific frequency can be avoided from being propagated without being attenuated.

### Third Embodiment

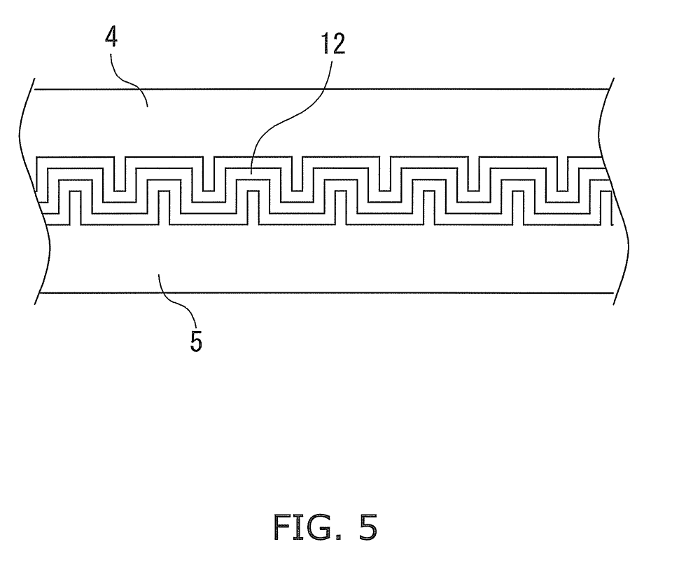

FIG. 5 shows an embodiment in which a low-speed electric signal line (for example, control signal line) or the like is wired (formed) along with the source wiring 4. 12 represents the low-speed signal line (for example, control signal line) provided in a meandering gap between the source wiring 4 and the ground wiring 5. The line 12 meanders between the source electrode 4 and the ground electrode 5 along with a gap between the source wiring 4 and the ground wiring 5.

This arrangement prevents malfunction due to external noise superimposed on the control line.

### Fourth Embodiment

Among battery-driven mobile devices such as a notebook computer, mobile phone, mobile terminal device and the like, a mobile device having a movable mechanism whose body is folded to store a display therein, for example, requires transmission of signals for display of information and supply of power from a battery via the movable mechanism. Wiring in such mechanisms is generally made using FPC (Flexible Printed Circuit) or thin coaxial wire array. However, lack of the wiring band due to highly advanced fine pattern of display image is growing into a problem year after year. Moreover, backflow of a signal transmitted to a display due to its leakage into or superposition over a power line or other wiring at the middle of a wiring is also growing into a serious problem. As a solution to such problems, high speed wiring in a display using the optical wiring has been proposed, but there is a problem that it is difficult to apply a general optical wiring to battery-driven devices due to high power consumption. Further, even if the optical wiring is used, an electric wiring for the power supply and the like of the display unit must be prepared separately, which results in the problem that the optical wiring and electric wiring are likely to converge with each other.

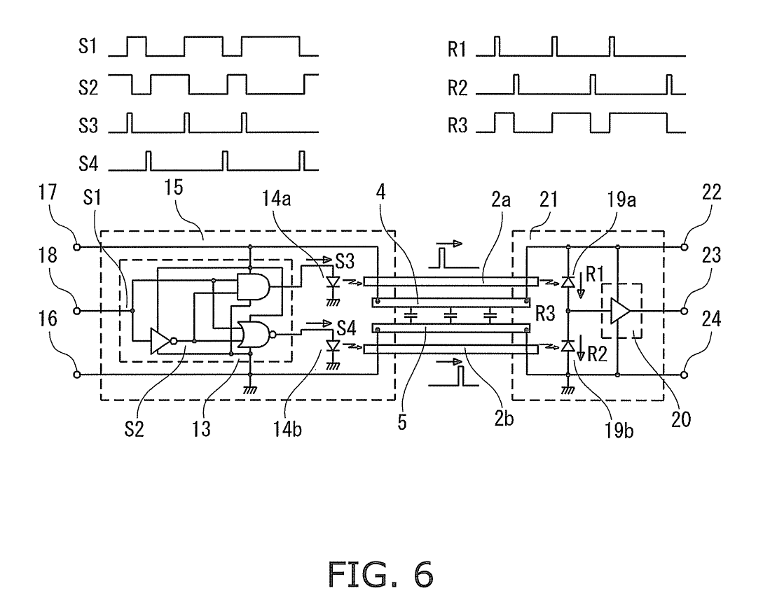

FIG. 6 is a configuration diagram according to the embodiment of the present invention which is adapted to fit to wirings in a movable part of a battery-driven mobile device. 15 represents a transmission module, 13 represents an optical element driver IC, 14a and 14b represent light-emitting elements, 21 represents a reception module, 20 represents a receiver IC, 19a and 19b represent light-receiving elements, 17 and 22 represent power supply terminals, 18 and 23 represent optical wiring signal terminals, and 16 and 24 represent ground terminals. 18 is a signal input terminal, and 23 is a signal output terminal. Here, 17 is used as a power supply input terminal and 22 is used as a power supply output terminal, but depending on the application, 22 may be used as a power supply input terminal and 17 may be used as a power supply output terminal. That is, such configuration may be used when a signal is transmitted from a display to a main body with a receiving module provided on the power supply side and a transmitting module provided on the power consumption side. Optical waveguides 2a and 2b correspond to use of two of the optical waveguide shown in FIGS. 1 and 2 as a pair.

Here, terminals are simplified by using a common voltage for supplying power from 17 to 22 and for supplying power to the optical wiring ICs 15 and 21. As a matter of course, transmission voltage of the power supply and supply voltage of the optical wiring ICs may be provided separately, in which case a dedicated electric wiring for power transmission may be provided. Otherwise, power supply for optical wiring ICs at transmission destination may be generated by a DC-DC converter at the transmission destination.

Circuit operations according to the present embodiment will be described. First, a digital signal inputted into terminal 18 (voltage waveform S1) is branched to two signals, that is, a signal passing through the NOT gate (voltage waveform S2) and a signal not passing through the NOT gate (the same voltage waveform S1). At this time, the signal which passed through the NOT gate has a logic inverted from the initial signal and becomes an inverted signal whose phase is delayed by a delay at the NOT gate.

Next, the two signals are further branched and inputted to the AND gate and the NOR gate respectively. As a result, the AND gate generates a short pulse having a pulse width corresponding to the delay time at the NOT gate only at a rise portion of the input signal (voltage waveform and current waveform S3), and the NOR gate generates a short pulse having a pulse width corresponding to a delay time at the NOT gate only at a fall portion of the input signal (voltage waveform and current waveform S4). That is, pulse rise information and pulse fall information of the input signal are outputted separately, then respectively inputted to light-emitting elements 14a and 14b and converted to discrete optical signals. Each of the optical signals is optically transmitted separately via a corresponding one of the optical waveguides 2a and 2b, and is inputted into the receiving module 21.

In the receiving module 21, the light-emitting element 19a generates short pulse current of input pulse rise information (current waveform R1), and the light-emitting element 19b generates short pulse current of input pulse fall information (current waveform R2). Each of the short pulse currents charges (current waveform R1) and discharges (current waveform R2) the combined capacitance of input capacitance of the receiver IC and parasitic capacitance of the light-receiving element. As a result, input voltage of the receiver IC 20 has an integrated waveform (voltage waveform R3) of respective light-reception currents, and the digital signal inputted into 18 is reproduced and outputted from 23. According to the present embodiment, waveform is reproduced by charging and discharging light-reception currents R1 and R2, for which input impedance of the receiver IC 20 needs to be very high. To obtain the impedance, a CMOS circuit may be used at an input stage of the receiver IC 20, for example.

Further, the receiving circuit is not limited to the configuration shown in FIG. 6. For example, output of the light-receiving elements 19a and 19b may be converted to voltage via resistance load or transimpedance amplifier and then inputted into the Set terminal and the Reset terminal of SR-FF (Set Reset Flip Flop) respectively to reproduce the input digital signal via a logic circuit.

In such configuration, only pulse edge information of a digital signal is optically transmitted, whereby optical wiring power can be reduced to, for example, ¼ or less of the power for performing optical transmission for the entire width of pulse data. For continuous data, power can be further reduced since the data contains no pulse edge information. In a case where average bit continuous length is 4 bits, optical wiring power can be reduced to approximately 1/10 of the power for performing optical transmission for the entire width of pulse data.

Further, configuration of the source wiring and the low-speed signal line shown in FIGS. 1 and 5 generates a coupling capacitance in distribution between the power supply wiring and the ground wiring, whereby noise components superimposed on the source wiring and the low-speed wiring can be eliminated. That is, according to the embodiments of the present invention, the source wiring or the low-speed signal wiring is disposed so as to face the ground wiring for a longer period than the wire length, which also has the effect that noise is absorbed automatically in the middle of the wiring. As a matter of course, more stable power supply wiring and low-speed signal wiring can be achieved by providing a decoupling capacitor between the source wiring and the ground wiring at an output end of the transmission module or at an input end of the receiving module.

Thus, in an optoelectronic wiring module shown in FIG. 6, it is possible to reduce optical wiring power significantly and therefore facilitate application of the optical wiring to battery-driven mobile devices. Further, since power can be supplied with less noise at the same time, the optoelectronic wiring module can be applied to wirings of movable portions of battery-driven mobile devices so as to increase the wiring capacity and fundamentally suppress electromagnetic noise by optical wiring.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An optoelectronic wiring film comprising:
an optical waveguide;
a ground wiring; and
a source wiring supplying power and being provided in the same wiring layer as the ground wiring, wherein
the source wiring has a comb-shaped portion and the ground wiring has a comb-shaped portion,
a gap between the source wiring and the ground wiring is substantially constant, and the comb-shaped portion of the source wiring and the comb-shaped portion of the ground wiring face each other so that the gap between the source wiring and the ground wiring meanders.

2. The optoelectronic wiring film according to claim 1, wherein a plurality of regions where the gap between the source wiring and the ground wiring meanders at different pitches is provided.

3. The optoelectronic wiring film according to claim 1, further comprising,
a signal line provided in the same wiring layer as the source wiring and the ground wiring, and provided in the gap between the source wiring and the ground wiring.

4. The optoelectronic wiring film according to claim 1, wherein a meandering width of the gap is constant in the optoelectronic wiring film.

5. The optoelectronic wiring film according to claim 1, wherein the optical waveguide is provided between the source wiring and the ground line, and below the gap between the source wiring and the ground wiring.

6. The optoelectronic wiring film according to claim 1, wherein the optical waveguide is provided below the comb-shaped portion of the source wiring.

7. The optoelectronic wiring film according to claim 1, wherein the optical waveguide is provided below the comb-shaped portion of the ground wiring.

8. The optoelectronic wiring film according to claim 1, wherein the comb-shaped portion of the source wiring and the comb-shaped portion of the ground wiring are disposed alternately in a manner not to contact each other.

9. A optoelectronic wiring module using the optoelectronic wiring film according to claim 1, wherein power is supplied from only one of an optical transmission side and an optical reception side of the optoelectronic wiring film, and
power is supplied to an optical element drive circuit on each of the optical transmission side and the optical reception side by use of the source wiring and the ground wiring of the optoelectronic wiring film.

10. The optoelectronic wiring module according to claim 9, wherein the optoelectronic wiring module optically transmits a digital signal and includes two optical waveguides having approximately the same lengths, and
pulse rise information of the inputted digital signal is optically transmitted through one of the optical waveguides, while pulse fall information of the inputted digital signal is optically transmitted through the other optical waveguide.
